(19) United States
(12) Patent Application Publication
(10) Pub. No.: US 2011/0272901 A1
(43) Pub. Date: Nov. 10, 2011

(54) MEDICAL CARE TROLLEY

(75) Inventor: Patrick INDERBITZIN, Chamoson (CH)

(73) Assignee: Decide Life International SA, Carouge (CH)

(21) Appl. No.: 13/103,224

(22) Filed: May 9, 2011

(30) Foreign Application Priority Data
May 7, 2010 (FR) 1053571

(51) Int. Cl. B62B 3/00

(52) U.S. Cl. 280/29

(57) ABSTRACT

The present invention relates to a medical care trolley comprising a frame (40) furnished with castors (2 to 5) and at least one drawer (6 to 13) and an item of computer equipment powered by rechargeable batteries, wherein the totality of the electrical means incorporated into the trolley operate directly at a single direct-current voltage and have no cooling fan.

This application claims priority benefits to French Patent Application Number 10 53571 filed May 7, 2010, the entire disclosure of which is herein incorporated by reference.

### BACKGROUND OF THE INVENTION

The present invention relates to a computerized trolley for medical care.

### DESCRIPTION OF THE PRIOR ART

Known in the prior art is the general principle of a mobile trolley for delivering medication, care and the medical file of the patient in a hospital. Known in particular are trolleys fitted with a laptop computer for consulting a digital file of the patient.

In particular, international patent application WO 2008/025901 is known describing a connectable, multimedia and multiservice mobile assembly for medical diagnosis and monitoring. This assembly consists of a directional rolling base and a cylindrical hollow body enclosing electrical powering means, identification means, computer means and multimedia communication means and a station for disinfecting hands and it is predisposed for its reception and its connection to a host station. This solution is of value notably to the manufacturers of trolleys intended for hospitals and care units.

Also known is the U.S. Pat. No. 5,702,115 describing a service trolley for making patient care easier. The trolley comprises a frame, wheels mounted on the frame and several side panels mounted on the frame in order to form two spaced vertical supports. At least one shelf is mounted between the supporting members. The shelf can be extended on each side of the trolley in two directions. A drawer that can be extended in two directions is mounted above the shelves. The console also comprises an item of computer equipment. Communication devices such as a two-way radiocommunication electronic circuit board is provided on the trolley for communication with a remote server.

Also known is the application US 2002013640 describing a computerized medication delivery station intended notably for the management of anesthetic medication. The narcotic and non-narcotic medications and the supplies for use in anesthesia are stored in receptacles attached to the mobile station. A computer housed in the station is intended to record the anesthesia articles that have been used and ensure the traceability of the use of the narcotic products in particular.

### DRAWBACKS OF THE PRIOR ART

The mobile trolleys of the prior art have several drawbacks.

First, the mobile trolleys pose a problem of autonomy. Certain trolleys require a connection to the mains, which requires manipulations each time the items of electrical equipment of the trolley are to be used and the risk of inadvertent disconnection.

Trolleys using power-supply batteries do not make it possible to achieve satisfactory autonomy and usually require a recharge before the end of a day of use and their service life is much too short.

Secondly, the trolleys of the prior art carry risks of bacterial transmissions causing risks of nosocomial infections, amplified by the fact that the trolley travels from patient to patient and has many recesses that are difficult to clean and disinfect.

Thirdly, the accessories of each trolley are specific to one model of trolley and are not interchangeable. This forces the hospitals to manage a stock of equipment that is difficult to develop.

### Solutions Provided by the Invention

The object of the present invention is to provide solutions to the drawbacks exhibited by the trolleys of the prior art.

### SUMMARY OF THE INVENTION

Accordingly, the invention relates, according to its broadest meaning, to a medical care trolley comprising a frame furnished with castors and at least one drawer and an item of computer equipment powered by rechargeable batteries, wherein the computer equipment is incorporated into the top portion of the trolley, operates directly at a single direct-current voltage and has no cooling fan.

The use of electronic circuit boards, of screens and of items of equipment each operating on one and the same single direct-current power supply voltage makes it possible to reduce the energy wastage that occurs in voltage converters.

This solution therefore, with given batteries, makes it possible to increase the autonomy of the mobile trolley.

Moreover, the use of an electronic circuit board with no cooling fan makes it possible not only to reduce consumption but also to prevent stirring the air carrying pathogenic agents.

According to a preferred embodiment, the top portion of the trolley comprises an inclined cover incorporating a display screen and an electronic circuit board housed under said cover, said electronic circuit board being cooled by the flow of internal air without passing through filters.

The absence of air filters prevents the stagnation of bacteria and other pathogenic or allergenic agents.

Preferably, the mobile trolley according to the invention comprises a low-voltage connector capable of interacting with a matching wall power socket.

This embodiment dispenses with carrying on the mobile trolley a power supply unit with a transformer and therefore makes it possible to reduce the weight of the trolley and to reduce the sources of bacterial contamination and therefore means that there is no need to have 220 V mains alternating-current on the mobile trolley.

According to an advantageous embodiment, the trolley comprises means for powering by induction capable of interacting with matching fixed means, thus avoiding the presence of a socket which constitutes a nest for bacteria, dust, etc. and is not easy to disinfect.

Advantageously, the trolley comprises means for magnetic locking of the frame onto a receiving zone, said locking means consisting of a permanent magnet.

The trolley requires no power supply for performing the locking, the electrical consumption occurring only when unlocking, by a member comprising an electromagnet producing a magnetic field temporarily resisting the magnetic fields of the magnetic magnet.

According to an advantageous embodiment, the frame is fitted with interchangeable internal walls having runners for receiving storage accessories.

These internal walls make it possible to adapt the trolley to any type of accessories and notably of drawers, and thus allows great modularity, and the reuse of accessories and drawers designed for other types of trolley.

Preferably, said interchangeable internal walls have lateral spacers for adaptation to preexisting accessories.

Advantageously, the trolley according to the invention comprises means for locking the trolley and securing all the computer and technical members of the trolley and all the drawers for the security of the patient file, of the medication and the whole content of the trolley.

In order to limit surface roughness, recesses and the assembly joints between various portions of the trolley, the frame and the drawers, and the various portions of the trolley, are made of molded plastic while the panels are made of injected hard thermoplastic.

Finally and again to limit the formation of nests of bacteria that are difficult to disinfect such as screw threads, each castor comprises a roller the rotation axis of which is secured to a fork, said fork being secured to a swivel joint, wherein said swivel joint is furnished with a nut secured to the swivel joint, said nut being placed inside a housing paired with a housing or projection of the bottom end of the frame furnished with a threaded rod onto which said nut is engaged for the attachment of the castor.

### DESCRIPTION OF THE DRAWINGS

The present invention will be described below with reference to a nonlimiting exemplary embodiment illustrated by appended drawings in which:

FIG. 1 represents a three-quarter view on the right front of a trolley according to the invention,

FIG. 2 represents a three-quarter view from the left front of a trolley according to the invention,

FIG. 3 represents a view of the trolley approaching the wall connector,

FIG. 4 represents a top view of the trolley in the connection phase,

FIG. 5 represents a view of the frame of the trolley according to the invention,

FIG. 6 shows in perspective a castor according to the invention.

### DESCRIPTION OF THE PREFERRED EMBODIMENT

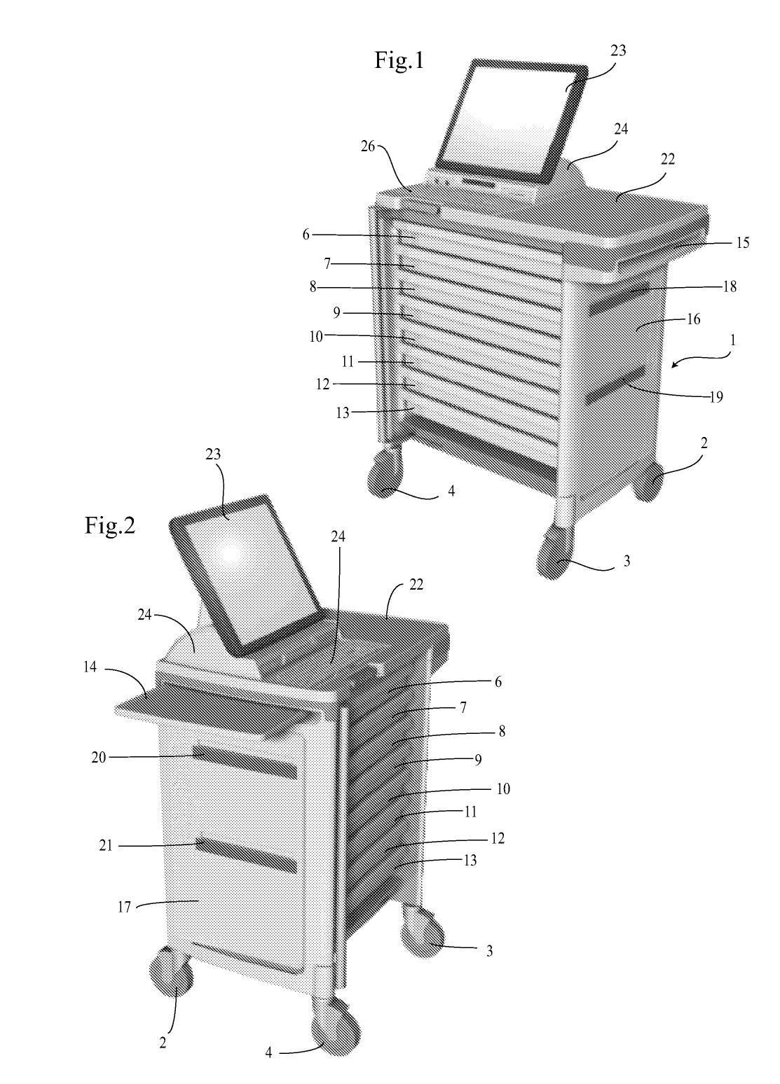

FIGS. 1 and 2 represent three-quarter front views of an exemplary embodiment of a trolley according to the invention.

The trolley comprises a body (1) furnished at its bottom portion with four steerable castors (2 to 5). This body (1) receives drawers (6 to 13). It also comprises on one side at least one retractable tray with an outlet on each side (14, 15).

The body (1) is furnished on the lateral sides (16, 17) with integrated geometry and/or with fitted bars (18 to 21) designed for the coupling of accessories such as storage baskets or bins.

The top tray (22) protrudes a long way beyond the lateral side (16) by a length corresponding substantially to the size of the accessories intended to be coupled to the ribs in order to protect them when passing through a door or a restricted space.

The top portion is fitted with a fixed touch-sensitive display screen (23) covered with a sealed, toughened glass tile and a housing fitted with a cover (24) to receive the electronic circuits. The cover (24) has openings for the connection of peripherals such as a USB key or the passage of an element for burning and reading a disk of the CD or DVD type. A sealed keyboard (26) is provided on the top tray (22).

The screen (23) can be disinfected on the contact area and the keyboard (26) is sealed and can be submerged for disinfection.

All of the electronic circuits and the peripherals (touch-sensitive screen, CD or DVD drive, hard disk, etc.) operate at the same nominal direct-current voltage, 12 volts in the example described.

The body and the drawers, and the various portions of the trolley, are made of molded plastic containing chemical agents for limiting the speed of flammability in compliance with the standard, and comply with the UL94V-0 standard. They are designed to have less than 10% of curved areas in which the radius of curvature is less than 3 millimeters. The surfaces are coated with an impact-resistant and scratch-resistant epoxy powder medical paint applied in a powder paint booth. This, on the one hand, eliminates any recess likely to constitute a nest for bacteria and, on the other hand, makes the job of disinfection easier by having a surface that is practically smooth and has no recesses that are difficult to access.

The body optionally comprises a drawer for a hanging file in order to allow the transition from all paper to all computer.

The care staff are identified by an RFID or equivalent reader (badge, barcode and barcode reader, CPS, or login-password, or biometrics); the equipment comprises a “care staff” card reader and/or a patient health card reader.

Optionally, the equipment comprises a negatoscope, for example on the rear portion of the screen.

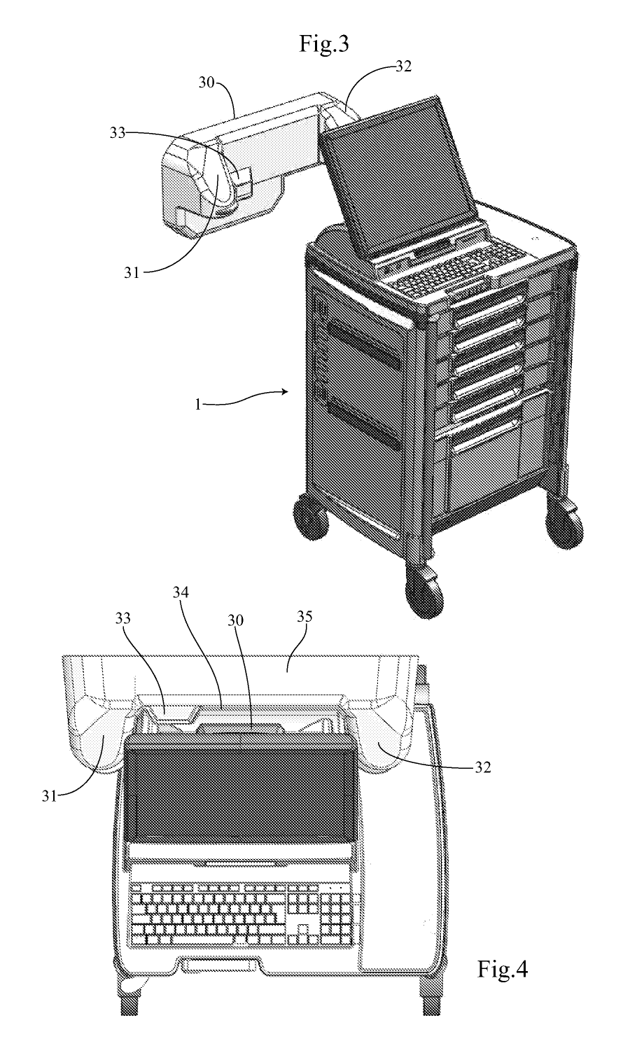

FIGS. 3 and 4 represent the mobile trolley and the wall connector (30). The wall connector (30) is designed to receive the top portion of the trolley (1) at the level of the portion receiving the electronic circuit boards. This disposition makes for easier visual guidance of the engagement of the trolley on the connector (30).

The connector has two wings (31, 32) forming a cone for the mechanical reception of the matching portion of the trolley. The connector has a socket (33) of frustoconical shape with rectangular section that is housed in a cavity of matching shape provided on the trolley. Electrical connection is achieved by direct-current low-voltage copper pins. Alternatively, if the trolley comprises power supply means by induction, the connector (30) comprises matching fixed means for charging the batteries without connection of the male connector and female connector type.

The mechanical locking of the trolley on the wall connector (30) is ensured by magnetic linkage by virtue of a permanent magnet (35) provided on the wall base and interacting with a matching metal or magnetic portion (34) of the trolley (30). The latter comprises an electromagnet producing a contrary field when it is powered. Powering is achieved via a manual sensor that can be activated by the staff handling the trolley in order to release it for use.

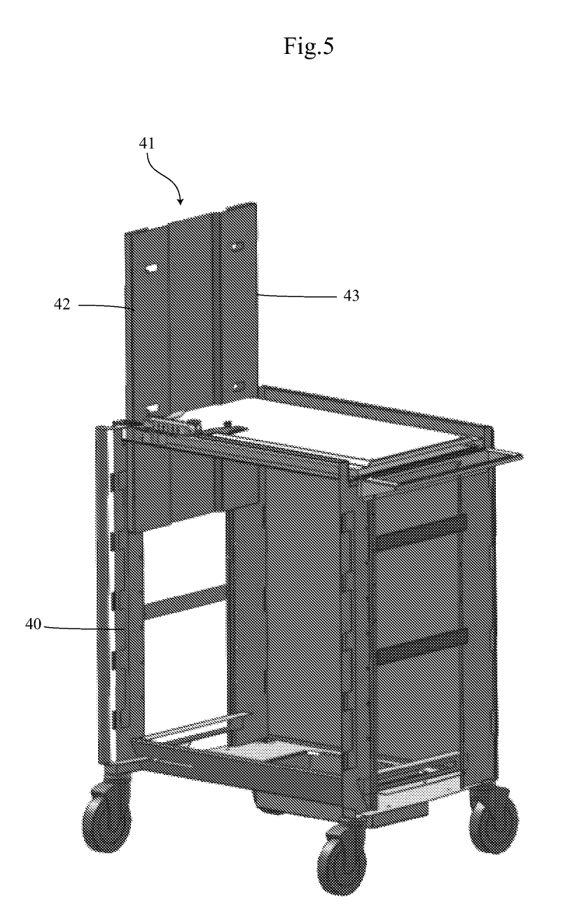

FIG. 5 represents a view of the frame of the trolley (40). It shows vertical runners for receiving interchangeable lateral panels (41). These panels (41) make it possible to adapt the trolley to any type of drawer, by spacers (42, 43) making it possible to adjust the width to suit existing drawers designed to be fitted to the trolley.

These interchangeable panels (41) are advantageously made of injected hard thermoplastic of the Ostaform (trade name) type.

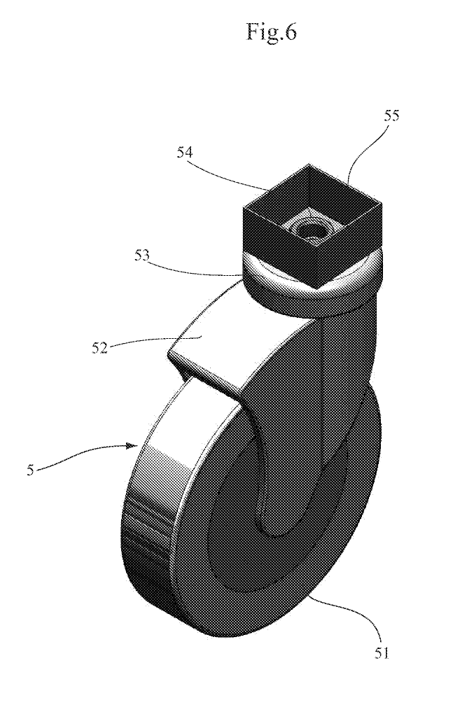

FIG. 6 shows a castor (5) making it possible to limit the creation of nests for bacteria. It comprises a roller (51) the rotation shaft of which is secured to a fork (52). The fork (52) is secured to a swivel joint (53). The swivel joint (53) is furnished with a nut (54) secured to the swivel joint. The nut (54) is placed inside a housing (55) paired with a housing or projection of the bottom end of the frame. Said housing or projection of the frame is furnished with a threaded rod (not shown) on which the nut (54) is engaged for attaching the castor (5) to the frame. The dimensions and shape of the housing (55), when the nut (54) is screwed onto the rod, make it possible for the housing to be paired with the frame or surround the projection of the frame with friction thus ensuring an assembly that is virtually sealed from bacteria.

According to a variant embodiment, the trolley also comprises a frame forming a “cart”, having a receptacle for receiving a conventional mobile trolley.

1. A medical care trolley comprising a frame (40) furnished with castors (2 to 5) and at least one drawer (6 to 13) and an item of computer equipment powered by rechargeable batteries, wherein the computer equipment is incorporated into the top portion of the trolley, operates directly at a single direct-current voltage and has no cooling fan.

2. The care trolley as claimed in claim 1, wherein the top portion of the trolley comprises an inclined cover incorporating a display screen, a central processing unit with an electronic circuit board housed under said cover, said electronic circuit board being cooled by the flow of internal air without passing through filters.

3. The care trolley as claimed in claim 1, which trolley comprises a low-voltage connector capable of interacting with a matching wall power socket.

4. The care trolley as claimed in claim 1, which trolley comprises means for powering by induction capable of interacting with matching fixed means.

5. The care trolley as claimed in claim 1, which trolley comprises means for magnetic locking of the frame onto a receiving zone, said locking means consisting of a permanent magnet.

6. The care trolley as claimed in claim 1, wherein the frame is fitted with interchangeable internal walls having runners for receiving storage accessories.

7. The care trolley as claimed in claim 6, wherein said interchangeable internal walls have lateral spacers for adaptation to preexisting accessories.

8. The care trolley as claimed in claim 1, which trolley comprises means for locking the trolley and securing all the computer and technical members of the trolley and all the drawers for the security of the patient file, of the medication and the whole content of the trolley.

9. The care trolley as claimed in claim 1, wherein the frame and the drawers, and the various portions of the trolley, are made of molded plastic while the panels are made of injected hard thermoplastic.

10. The trolley as claimed in claim 1, wherein each castor (2 to 5) comprises a roller (51) the rotation axis of which is secured to a fork (52), said fork being secured to a swivel joint (53), wherein said swivel joint (53) is furnished with a nut (54) secured to the swivel joint, said nut (54) being placed inside a housing (55) paired with a housing or projection of the bottom end of the frame furnished with a threaded rod onto which said nut (54) is engaged for the attachment of the castor.
